(19) United States
(12) Patent Application Publication
(10) Pub. No.: US 2026/0339937 A1
(43) Pub. Date: Oct. 29, 2026

(54) Agentic Approach for Threat Hunting Query Pipeline

(71) Applicant: International Business Machines Corporation, Armonk, NY (US)

(72) Inventors: Kevin Eykholt, White Plains, NY (US); Ariel Blobstein, Mazkeret Batya (IL); Yair Allouche, Dvira (IL); Jiyong Jang, Chappaqua, NY (US); Teryl Paul Taylor, Colorado Springs, CO (US); Shriti Priya, White Plains, NY (US); Youngja Park, Princeton, NJ (US); Ofer Haim Biller, Neve Boker (IL); Ian Michael Molloy, Westchester, NY (US); Xiaokui Shu, Ossining, NY (US); Frederico Araujo, Mahopac, NY (US); Dhilung Hang Kirat, Hartsdale, NY (US)

(21) Appl. No.: 19/186,923

(22) Filed: Apr. 23, 2025

(51) Int. Cl. G06F 16/2452; G06F 16/242

(52) U.S. Cl. CPC G06F 16/24522; G06F 16/243

(57) ABSTRACT

Generating queries is provided. The method comprises receiving input of a natural language prompt regarding computer system or network activity. A large language model rewrites the natural language prompt to produce a rewritten prompt, wherein the rewriting maps natural language descriptions of system behaviors to computer or network system actions and objects. The large language model generates a set of intermediate queries based on the rewritten prompt, wherein the intermediate query is in a language on which the large language model is trained. The set of intermediate queries is translated into a threat hunting query expressed in a threat hunting query language specific to a database that records the computer system or network activity. The threat hunting query is validated according to whether it is semantically valid and executable. Responsive to a successful validation of the threat hunting query, executing the threat hunting query is executed against the database.

### BACKGROUND

The disclosure relates generally to computer system security, and more specifically to a method of generating targeted queries to systems without requiring specific user knowledge of the system language.

Logging systems monitor system and network activity and generate massive data that is often stored in multiple databases. Security analysts need to sift through the massive amount of data to identify suspicious events and respond to any security incidents in a timely manner. Thus, proficiency in query languages is crucial for threat hunters to effectively analyze and respond to security incidents. Due to the variety of threat hunting query languages available (e.g., Splunk SPL, KQL, Kestrel, XQL, Elasticsearch, Sigma), there is a significant knowledge overhang in becoming proficient in a specific language. Even experienced hunters may need to learn a new language based on company or community preferences.

### SUMMARY

An illustrative embodiment provides a computer-implemented method of generating queries. The method comprises receiving input of a natural language prompt regarding computer system or network activity. A large language model rewrites the natural language prompt to produce a rewritten prompt, wherein the rewriting maps natural language descriptions of system behaviors to computer or network system actions and objects. The large language model generates a set of intermediate queries based on the rewritten prompt, wherein the intermediate query is in a language on which the large language model is trained. The set of intermediate queries is translated into a threat hunting query expressed in a threat hunting query language specific to a database that records the computer system or network activity. The threat hunting query is validated according to whether it is semantically valid and executable. Responsive to a successful validation of the threat hunting query, executing the threat hunting query is executed against the database. According to other illustrative embodiments, a computer system and a computer program product for generating queries are provided.

### BRIEF DESCRIPTION OF THE DRAWINGS

FIG. 1 is a block diagram of a computing environment in accordance with an illustrative embodiment;

FIG. 2 depicts a diagram illustrating an overview of a query generation agent in accordance with an illustrating embodiment;

FIG. 3 depicts a diagram illustrating a detailed view of the operation of a query generation agent in accordance with an illustrative embodiment;

FIG. 4 depicts a depicts a flowchart illustrating a method for generating queries in accordance with an illustrative embodiment; and

FIG. 5 depicts a depicts a flowchart illustrating a method for translating the set of intermediate queries into the threat hunting query in accordance with an illustrative embodiment.

### DETAILED DESCRIPTION

The illustrative embodiments recognize and take into account that a key challenge is that hunters may be skilled at describing system behavior but may not be familiar with the specific syntax and functions required by each query language. This lack of familiarity can lead to errors and inefficiencies in threat hunting activities.

The illustrative embodiments also recognize and take into account that another key challenge is that query generation often demands extensive knowledge of the security domain, familiarity with relevant terms, and a deep understanding of how to construct an effective query. As a result, query generation is not merely a simple translation from natural language to the target querying language. Instead, it is a complex task requiring deep security expertise and a thorough familiarity with how data is represented and stored in different databases.

The illustrative embodiments also recognize and take into account that a query generation agent designed for production use has demanding requirements, including achieving accuracy levels that often exceed SOTA benchmarks, supporting a wide range of querying languages with ease, managing the number of LLM calls to control costs and latency effectively, and accommodating highly diverse prompts that may be very general and include terms and slang.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

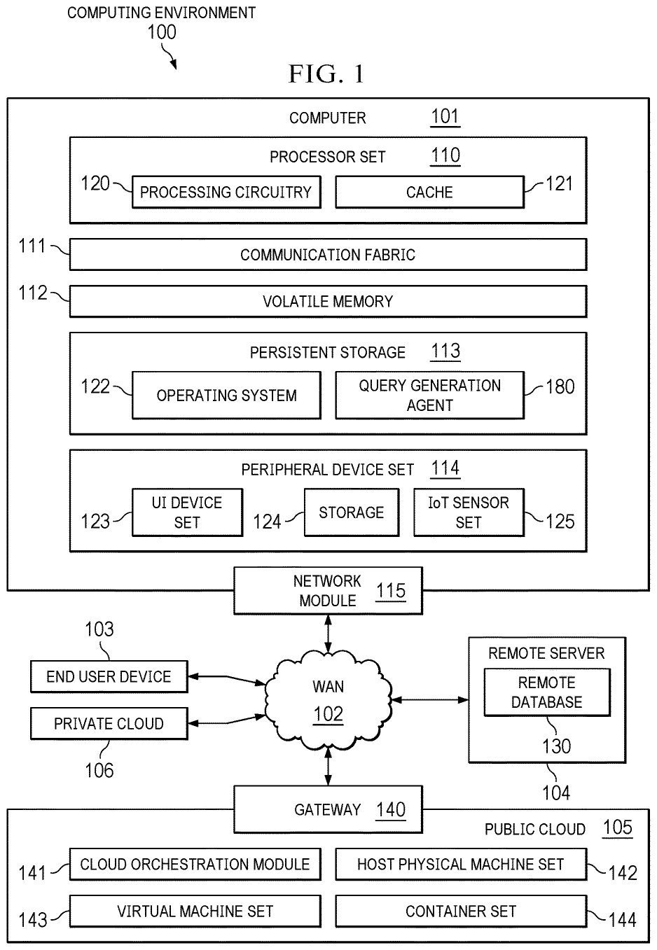

FIG. 1 shows a pictorial representation of a computing environment in which illustrative embodiments may be implemented. Computing environment 100 contains an example of an environment for the execution of at least some of the computer code involved in performing the inventive methods, such query generation agent 180.

In addition to query generation agent 180, computing environment 100 includes, for example, computer 101, wide area network (WAN) 102 end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and query generation agent 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141 host physical machine set 142 virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1 On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in query generation agent 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in query generation agent 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101 Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these V CEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to a “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments can be implemented as a Software as a Service model (SaaS) or using an existing infrastructure. The flexibility of deployment allows an organization to utilize the best option for their needs. A PI connectors can be leveraged to get data from various systems like SIEM (Security Information and Event Management) or EDR (Endpoint Detection and Response). This connection method allows the organization to add as many systems as needed through the API connector.

The illustrative embodiments provide a query generation pipeline that leverages an agentic framework, large language models (LLMs), and RAG (Retrieval-Augmented Generation) processes to bridge the gap between system behavior described in natural language and a query language description. The pipeline can be used to facilitate interaction between human threat hunters and security-related data sources (such as SIEM, XDR, etc.) or, alternatively, allows LLM applications (such as LLM-based threat hunting agents) to interact with these data sources. In this case, our invention can be considered an agent tool that bridges the gap between LLM agents and security-related repositories.

The illustrative embodiments provide a novel agentic framework that empowers users or systems (such as LLM-based agents) to perform threat hunting and investigative actions using natural language on security-related repositories like SIEM (Security Information and Event Management), XDR (Extended Detection and Response), and others. This framework is engineered for high accuracy, supports various querying languages, and accommodates diverse prompts.

The illustrative embodiments operate through several components. The first step involves creating a clear and rewritten prompt using knowledge retrieval and fusion. This self-contained prompt is clear and includes a detailed step-by-step plan for generating a query. It is independent of any specific deployment or pipeline. In the second stage, an LLM converts the rewritten prompt into a query. The LLM is provided with the rewritten prompt and a refined schema containing all relevant information. The LLM generates an intermediate query, fine-tuned for a single intermediate language (e.g., SQL, Sigma). This intermediate query is then converted into the target querying language (e.g., PySigma). The final stage validates the generated queries using language-specific rules and corrects any errors if validation issues arise. The query generation agent can optionally use API tools to execute the query against a backend database and refine the query based on the results (e.g., compilation errors, empty results). These components can interact as a multi-actor system, where each component functions as a separate actor (see LangGraph as an example), or as a multi-agent system, where each component operates as a separate agent.

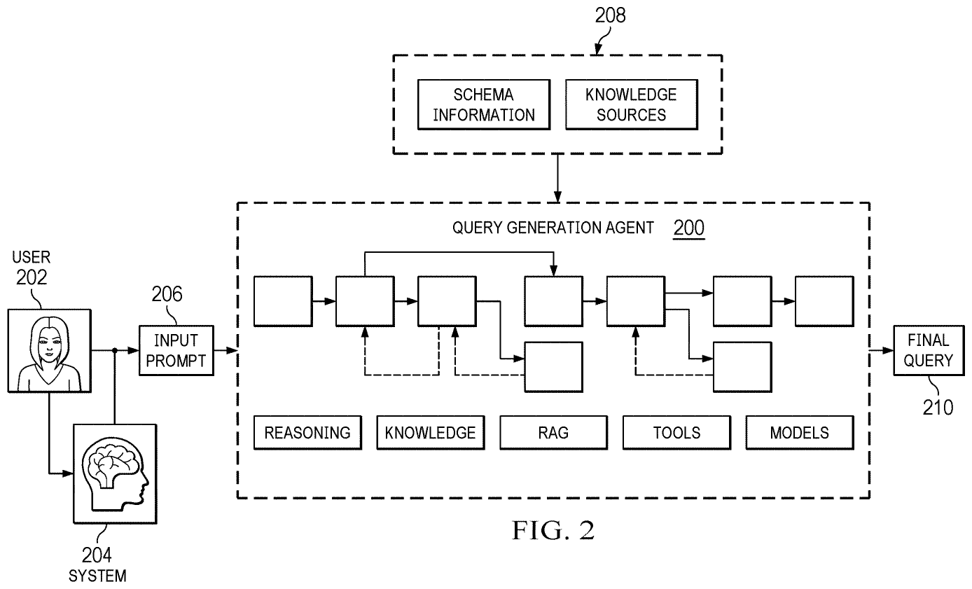

FIG. 2 depicts a diagram illustrating an overview of a query generation agent in accordance with an illustrating embodiment. Query generation agent 200 is an example of query generation agent 180 in FIG. 1.

The agentic framework of the illustrative embodiments can understand the input prompt, enrich the input prompt with additional domain knowledge, generate a threat hunting query, and validate the syntactic correctness of the query. The input prompt 206 can be from a user 202 or from the output of another system 204 such as an LLM based agent.

A prompt rewriting component in the query generation agent 200 converts the natural language input prompt 206 (which may be vague and generic) into several simplified and concrete natural language prompts. Query generation agent 200 employs prompt normalization, which can help with input prompts that lack language precision and domain specificity. Prompt normalization transforms the input prompt into a canonical prompt format that explicitly captures the key elements of a threat hunting query (i.e. the computer system subjects, objects, and actions involved in security-relevant behavior).

Some information in the input prompt requires specialized knowledge or contextual information that is not present in the prompt. Knowledge infusion occurs in three steps. First, it identifies intervention points in the natural language prompt that can benefit from external knowledge retrieval or clarification from the user. Second, it retrieves the external knowledge from connected data sources 208 or from the user 202. Third, it infuses the knowledge by rewriting the input prompt 206 to contain the retrieved knowledge.

Query generation agent 200 also employs query planning. Many queries contain a composition of multiple subqueries. Query planning breaks down the input prompt 206 into a step-by-step plan wherein each step defines a query action such as filtering or projection. The final query 210 is based on the generated query plan.

Due to the variety of threat hunting query languages, query generation agent 200 first converts the natural language prompt into an intermediate query representation which is independent from the query languages. Afterwards, query generation agent 200 maps the intermediate representation to a user specified threat hunting language by retrieving relevant schema and syntax rules. If a specialization for a particular query language is required, this capability is extended by an LLM fine-tuned for the specific threat hunting language and schema.

Query generation agent 200 employs a validation and execution capability that, given a set of language-specific rules, validates the correctness of generated queries and fixes the errors if validation errors occur. When the validation is completed, the query generation agent 200 can optionally use API tools to execute the final query 210 against a backend database.

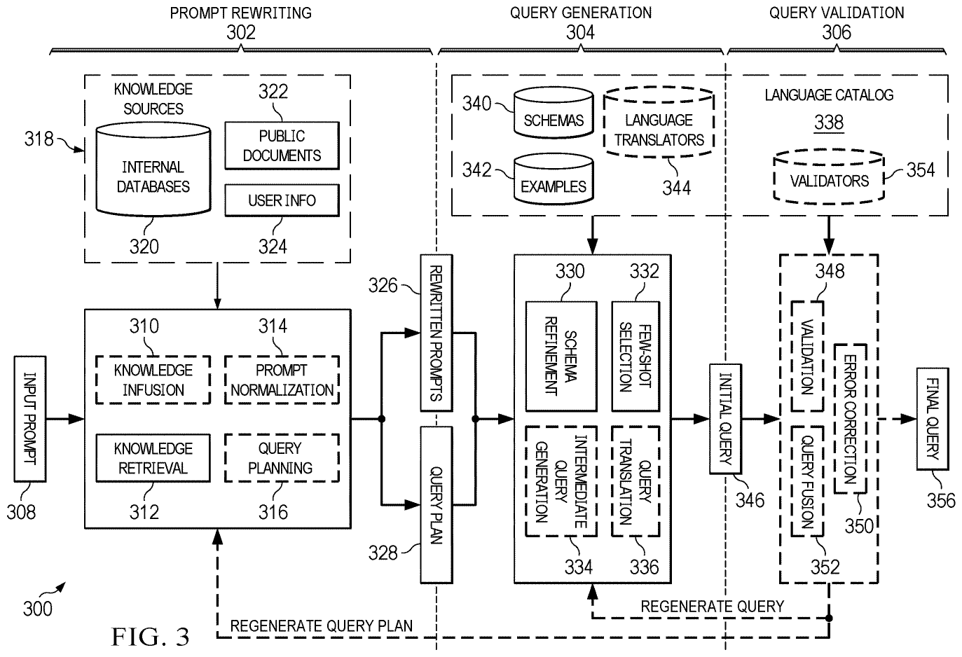

FIG. 3 depicts a diagram illustrating a detailed view of the operation of a query generation agent in accordance with an illustrative embodiment. Query generation pipeline 300 can be implemented in query generation agent 200 in FIG. 2. Query generation pipeline 300 can be divided into prompt rewriting 302, query generation 304, and query validation 306.

Prompt rewriting 302 converts the natural language input prompt 308 into rewritten prompts 326 and a step-by-step query plan 328. Prompt rewriting 302 converts security terms into natural language descriptions, and maps described threat behaviors or user questions into computer or network system actions and objects. It identifies necessary external know sources 318 and performs knowledge retrieval 312 of relevant information to enrich the query.

To improve the accuracy and stability of the query generation pipeline 300, input prompts 308 are normalized into a canonical representation that partitions the prompt into three system categories: subjects, actions, objects. Subjects denote operating system concepts such as processes, users, etc. Objects include processes, files, network endpoints, etc. Actions denote an operation type (e.g., execute a process, open a file, communicate over the network) performed by subjects on objects. Prompt normalization 314 can be achieved through a combination of methods and heuristics, including natural language syntax tree processing and LLM (Large Language Model)-based methods, such as in models that have been tuned and instructed for this task.

To ensure that terms in the input prompt 308 are accurately typed and partitioned, domain knowledge of computer and operating systems concepts must be infused in the query generation pipeline 300. For example, an additional classification and pre-processing step can tag terms to their types. Alternatively, an LLM can be trained on this domain-specific knowledge to accurately partition prompt terms.

Once the initial partitioning is obtained, prompt normalization 314 of term values is performed using domain-specific, bounded enumerations for each type in the partitioning of subjects, actions, and objects. In an embodiment, known operating system processes and services, special users and groups, operating system-specific object paths, actions, etc. are mapped to precise and normalized lists of values that comprehensively describe all inhabitants of that type (e.g., [clone, fork, spawn, execute, . . . ] map to spawn, [sudo, su, suexec, critical-stack, dzdo] map to user execution binaries).

Identification of missing types in the partition is also performed to potentially solicit user's or agent's assistance and/or clarification. In an embodiment, the prompt originator (a user, or an agent in a multi-agent setting), can be interrogated to solicit additional information that would make the prompt semantically complete and unambiguous.

The final partitioning is then used to rewrite the prompt following a template. In an embodiment, an LLM can be instructed to generate the normalized prompt.

Threat hunting databases will contain detailed information about any system activity that has occurred and the relevant metadata. For example, if a process is started, the database would have a row containing information such as the process name, the command line logs, the parent process, the files that were touched, etc. However, the database does not provide the labels of this data, nor associate it with certain high-level concepts. Traditionally, the mapping between high-level concepts and the database schema is done by human experts. Thus, query generation for threat hunting languages may require knowledge that exists outside of the database schema. For example, consider the following user prompt, “Find SMB connections in my organization.”

Someone who is only familiar with the database schema would be unable to write a query for the above input. “SMB connections” and “my organization” are aliases for a certain set of conditions and need additional context to be fully understood. An SMB connection denotes network activity where the common port number is either 139 or 445, and “my organization” requires the user to define the IP address range.

Query generation pipeline 300 employs knowledge infusion 310 to resolve external knowledge dependencies. Given the input prompt 308, an LLM identifies if there are any intervention points in the input prompt. An intervention point is a portion of the prompt that appears to alias a system behavior. There are multiple methods to identify intervention points using an LLM such as LLM Q&A wherein, given the input prompt, the LLM asks questions to get more details about the adjectives, proper nouns, and phrases in the prompt. Intervention points are the questions generated. Another method is LLM Decomposition wherein, given the input prompt 308, the LLM decomposes the prompt into a structured format such as subject-action-object-conditions. The process then iterates through the tuples and determines if any of the values are sufficiently defined based on a heuristic. Intervention points are the values that are insufficiently defined such as a tuple without a condition.

If any intervention points are generated, knowledge infusion 310 will attempt to resolve them by knowledge retrieval 312 from connected external knowledge sources 318, which can comprise public documents 322 on the internet (e.g., threat intelligence blog post) or internal knowledge databases 320 the organization maintains. Through tool calling API's and RAG processes, knowledge infusion 310 can retrieve relevant knowledge documents and extract the potentially relevant sections in the document. Knowledge infusion 310 can also ask for user information 324 such as whether the information required is contextual (e.g., my organization, rare events, etc.) and store contextual definitions internally. Any retrieved information is provided to the LLM, which is instructed to rewrite the input prompt 308 based on the retrieved information if it helps to resolve the intervention points.

LLMs are known to hallucinate and can be sensitive to small changes in the input. These issues are magnified as task complexity increases, such as user inputs that require joining the output of several queries. To mitigate these issues, the illustrative embodiments apply query planning 316, which breaks down the given task into a sequence of steps, with each step representing a distinct element of a query that includes a specific behavior (e.g., filter condition or aggregation function, join clause, etc).

For example, the user prompt: “Display rare executions of Rundll32 being executed from syswow64, rare could be stated as 5 or less executions” could be decompose into: 1) Filter the data to only include executions of Rundll32 where the process image name matches ‘rundll32.exe’; 2) Filter the data to only include executions of Rundll32 where the process image path contains the directory ‘syswow64’; 3) After we filtered results by process image name and path, we now need to arrange them so we need to create a counter for each unique combination of process_path, process_cmd, parent_path, parent_cmd, cgo_path, and cgo_cmd; 4) Filter the data to only include instances with a counter value less of 5 or less, indicating rare executions of Rundll32; and 5) Sort the results in descending order based on the counter value to prioritize the most frequent executions of Rundl32 from syswow64. The decomposition can be handled by an LLM.

Steps can be dependent on the results of previous steps. In the abovee example, steps 1-2 each define a new filter condition, which can be combined with an “AND” operator. Step 3 requires an aggregation of a combination of columns in order to count executions. Step 4 filters the count of executions to answer the condition “5 or less” execution. Step 5 sorts the results by the number of executions. In more complicated cases, such as when a JOIN clause is needed, query planning 316 may result in two sets of steps, one for each subquery in the JOIN clause. In all cases, such dependencies are resolved in the query fusion step. These dependencies are generated during query planning 316 and passed to a query fusion module. After query generation has generated the subqueries for each step, query fusion combines the subqueries based on the dependencies to produce query plan 328.

Query generation 304 creates queries in a specified threat hunting language by retrieving the threat hunting language schema 340 from a language catalog 338 and perform filtering to extract relevant portions of the schema based on the query plan 328. Few-shot (Natural Language, query) examples 342 are retrieved and optionally filtered based on semantic relevance to the query plan and filtered schema. For each step of the query plan 328, a generative model prompted with the above information generates a subquery. Subqueries are then joined together based on the query plan 328.

After rewriting the input prompt 308 to generate rewritten prompts 326, query generation pipeline 300 generates a query in the target threat hunting query language. We use a two-step generation approach. Intermediate query generation 334 generates an intermediate representation from the rewritten input prompt 326. The intermediate representation is then translated into a threat hunting query language. For example, SQL (Structured Query Language) could act as an intermediate language because most LLMs have seen SQL data, and it is easy to translate due to structural and syntactical similarities with other query languages.

To generate the intermediate representation from the rewritten prompt 326, schema refinement 330 first identifies potentially relevant parts of the schema in question, i.e. the tables and columns that the final query should search for reference. Relevance can be established through a variety of NLP (Natural Language Processing) techniques. For example, if embeddings of the words in the query and schema are generated, their similarity can be measured via cosine similarity or some other metric. “Relevance” in this case can be measured via similarity. In an alternative approach, an LLM that is trained via natural language can be asked to select “relevant” items based on its own internal representations of the language and understanding. For example, a simple rewritten prompt might say, “Find all processes with a name in the list [example, example2.exe, example3].” From this prompt, it is known that columns/tables about process information is relevant. More precisely, it can be determined that process name is relevant for the filter. All other columns/tables (e.g., network information) are not necessary to forward to the query generation step. Assuming three tables [process, network, users], a vector embedding of the query and a vector embedding of the table names can be created. A similarity metric (e.g., cosine similarity) is computed, which might lead to the discovery that the process table is most relevant. The column names could then be extracted (for additional precision) and repeat the procedure but embed the column names instead. The top K (e.g., top 10 or top 20%) most similar columns could be selected and marked as relevant.

For each supported threat hunting query language, there is a database of schema files in schemas 340. These files may contain table names and table descriptions, column names, column data types, and column descriptions, ENUM (enumeration type) value definitions if the column data type is an ENUM type, and a mapping between schema objects (i.e., tables and columns) and system objects, (e.g., file, endpoint, process, registry, user, etc.).

Given a rewritten input prompt 326, if a mapping between schema objects and system objects is provided, the LLM chooses one or more system objects that could be useful for answering the rewritten input prompt 326. Schema refinement 330 creates a refined schema that only contains some of the pre-defined base schema objects, e.g., timestamp data or local hostname, and the schema objects the LLM identified previously. This refined schema and the rewritten input prompt 326 are provided to a second stage that selects the top-N tables and top-K columns from each table that are the most relevant for query generation. An LLM can be used for this second stage, but it can be replaced with other selection methods such as selection based on embedding similarity.

Few-shot selection 332 selects few-shot examples from a library of examples 342 for the target threat hunting query language. A few-shot example is stored in the library as a (natural language input, intermediate language query) pair with the embedding of the natural language input serving as the index. The examples closest in the embedding space to the embedding of the rewritten input prompt based on some distance metric, e.g. cosine similarity, are selected. Additional filtering can be performed by only selecting examples that use information contained in the refined schema from the previous step.

The refined schema, the few-shot examples, and the rewritten prompts are provided to an LLM with the instruction to generate a SQL initial query 346 Query translation 336 translates the SQL query into the threat hunting query (e.g., using a SQL2THL translator). Fixed mappings between SQL syntax and the target threat hunting language may exist, such as language specific functions, which are stored in language translators 344. The illustrative embodiments leverage these fixed mappings whenever available. In lieu of a fixed mapping, the LLM can use mapping examples.

Query validation 306 determines whether the initial query 346 is semantically valid and executable. Query validation 306 validates the generated initial query 346 against stored grammar rules and a stored database if available. Any returned error messages are returned, and the LLM is asked to fix the query based on the error messages. If errors persist, query generation pipeline 300 regenerates the query plan.

LLMs are known to hallucinate, a phenomenon wherein they output factually incorrect or out of context information (e.g., usage of non-existing column names). The query validation step 306 ensures query correctness with respect to the target query language's specifications and grammar. The illustrative embodiments leverage two methods: offline and online validation. ANTLR (Another Tool for Language Recognition) grammar is often used to specify query language grammar, which the illustrative embodiment use for local validation 348 of the syntax of the initial query 346. If the deployment of a target database containing validators 354 provides an API endpoint to validate a query, validation 348 also uses this API endpoint to ensure it matches with the language specification. In cases where validation 348 fails, both methods often return informative error messages, which are used in error correction 350. The previously generated initial query 346 and the error messages are passed to an LLM, which attempts to make the necessary corrections and regenerate the query. This corrected query is then revalidated.

Fixing can also be performed by triggering one of the other agent capabilities to regenerate its output, which could be a result of improper planning or insufficient details for query generation. The validation errors or construction criticism are provided to either the query generation 304 or the prompt rewriting 302 depending on the persistence of query errors from attempted validation. For example, the query fusion component 352 may recognize that two of the intermediate queries have no dependencies and thus it is unable to merge them. It tells the query planning component 316 of this issue and asks it for a new query plan based on this feedback. After successfully validation 348, a final query 356 is generated that can be executed against a database to search for system/network threats.

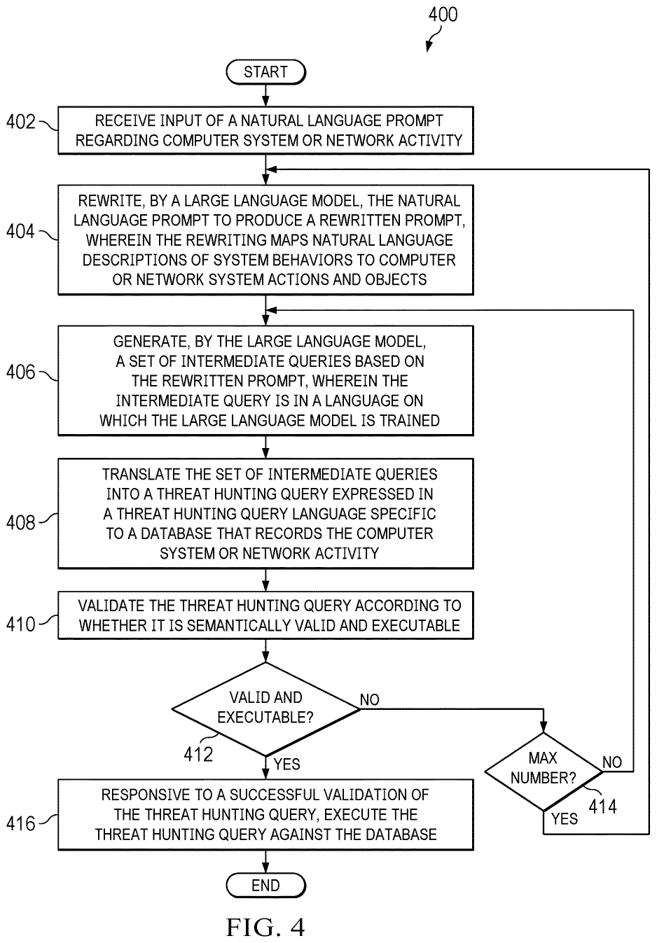

FIG. 4 depicts a depicts a flowchart illustrating a method for generating queries in accordance with an illustrative embodiment. Process 400 can be implemented in computing environment 100 in FIG. 1 and query generation agent 300 in FIG. 3.

Process 400 begins by receiving input of a natural language prompt regarding computer system or network activity (step 402).

A large language model rewrites the natural language prompt to produce a rewritten prompt (step 404). The rewriting maps natural language descriptions of system behaviors to computer or network system actions and objects. Rewriting the prompt comprises knowledge infusion of expert knowledge from a number of data sources external to the large language model, wherein the rewritten prompt include the expert knowledge. Rewriting the prompt further comprises query planning, wherein the prompt is organized into a number of sequential steps that define different query actions. Rewriting the prompt also comprises normalizing the prompt into a canonical representation that partitions the prompt into computer system categories of subjects, actions, and objects.

The large language model then generates a set of intermediate queries based on the rewritten prompt (step 406). The intermediate query is in a language on which the large language model is trained.

The set of intermediate queries is translated into a threat hunting query expressed in a threat hunting query language specific to a database that records the computer system or network activity (step 408).

Process 400 validates the threat hunting query according to whether it is semantically valid and executable (step 410). Validating the threat hunting query comprises at least one of comparing the threat hunting query against store grammar rules or comparing the threat hunting query against and endpoint of the database.

Responsive to a successful validation of the threat hunting query (as determined in step 412), the threat hunting query is submitted to the database (step 416).

Responsive to an unsuccessful validation, process 400 determines whether it has reached a specified maximum number of unsuccessful validations (step 414). If process 400 has not reached the specified maximum number of unsuccessful validations, it returns to step 406 and generates a new query. If process 400 has reached the specified maximum number of unsuccessful validations, it returns to step 404 and rewrites the prompt. Process 400 then ends.

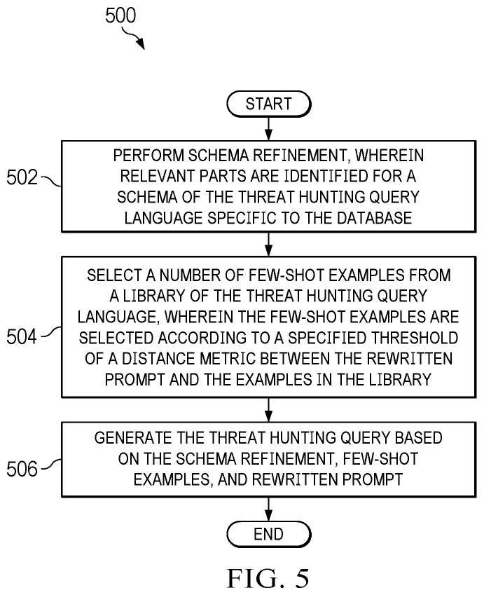

FIG. 5 depicts a depicts a flowchart illustrating a method for translating the set of intermediate queries into the threat hunting query in accordance with an illustrative embodiment. Process 500 is a detailed example of step 408 in FIG. 4.

Process 500 begins by performing schema refinement, wherein relevant parts are identified for a schema of the threat hunting query language specific to the database (step 502). Process 500 selects a number of few-shot examples from a library of the threat hunting query language (step 504). The few-shot examples are selected according to a specified threshold of a distance metric between the rewritten prompt and the examples in the library. The threat hunting query is generated based on the schema refinement, few-shot examples, and rewritten prompt (step 506). Process 500 then end.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A ; one of item B; and ten of item C; four of item B and seven of item C; or other suitable combinations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A computer-implemented method for generating queries, the method comprising:
using a number of processors to perform:
receiving input of a natural language prompt regarding computer system or network activity;
rewriting, by a large language model, the natural language prompt to produce a rewritten prompt, wherein the rewriting maps natural language descriptions of system behaviors to computer or network system actions and objects;
generating, by the large language model, a set of intermediate queries based on the rewritten prompt, wherein the intermediate query is in a language on which the large language model is trained;
translating the set of intermediate queries into a threat hunting query expressed in a threat hunting query language specific to a database that records the computer system or network activity;
validating the threat hunting query according to whether it is semantically valid and executable; and
responsive to a successful validation of the threat hunting query, executing the threat hunting query against the database.

2. The method of claim 1, wherein rewriting the prompt further comprises knowledge infusion of expert knowledge from a number of data sources external to the large language model, wherein the rewritten prompt includes the expert knowledge.

3. The method of claim 1, wherein rewriting the prompt further comprises query planning, wherein the prompt is organized into a number of sequential steps that define different query actions.

4. The method of claim 1, wherein rewriting the prompt further comprises normalizing the prompt into a canonical representation that partitions the prompt into computer system categories of subjects, actions, and objects.

5. The method of claim 1, wherein translating the set of intermediate queries into the threat hunting query further comprises:
performing schema refinement, wherein relevant parts are identified for a schema of the threat hunting query language specific to the database;
selecting a number of few-shot examples from a library of the threat hunting query language, wherein the few-shot examples are selected according to a specified threshold of a distance metric between the rewritten prompt and the examples in the library; and
generating the threat hunting query based on the schema refinement, few-shot examples, and rewritten prompt.

6. The method of claim 1, wherein validating the threat hunting query further comprises at least one of:
comparing the threat hunting query against store grammar rules; or
comparing the threat hunting query against and endpoint of the database.

7. The method of claim 1, wherein validating the threat hunting query further comprises:
responsive to unsuccessful validation of the threat hunting query, regenerating the threat hunting query; and
responsive to a specified number of unsuccessful validations of the threat hunting query, rewriting the prompt again.

8. A system for generating queries, the system comprising:
a storage device that stores program instructions;
one or more processors operably connected to the storage device and configured to execute the program instructions to cause the system to:
receive input of a natural language prompt regarding computer system or network activity;
rewrite, by a large language model, the natural language prompt to produce a rewritten prompt, wherein the rewriting maps natural language descriptions of system behaviors to computer or network system actions and objects;
generate, by the large language model, a set of intermediate queries based on the rewritten prompt, wherein the intermediate query is in a language on which the large language model is trained;
translate the set of intermediate queries into a threat hunting query expressed in a threat hunting query language specific to a database that records the computer system or network activity;
validate the threat hunting query according to whether it is semantically valid and executable; and
responsive to a successful validation of the threat hunting query, execute the threat hunting query against the database.

9. The system of claim 8, wherein rewriting the prompt further comprises knowledge infusion of expert knowledge from a number of data sources external to the large language model, wherein the rewritten prompt includes the expert knowledge.

10. The system of claim 8, wherein rewriting the prompt further comprises query planning, wherein the prompt is organized into a number of sequential steps that define different query actions.

11. The system of claim 8, wherein rewriting the prompt further comprises normalizing the prompt into a canonical representation that partitions the prompt into computer system categories of subjects, actions, and objects.

12. The system of claim 8, wherein translating the set of intermediate queries into the threat hunting query further comprises:
performing schema refinement, wherein relevant parts are identified for a schema of the threat hunting query language specific to the database;
selecting a number of few-shot examples from a library of the threat hunting query language, wherein the few-shot examples are selected according to a specified threshold of a distance metric between the rewritten prompt and the examples in the library; and
generating the threat hunting query based on the schema refinement, few-shot examples, and rewritten prompt.

13. The system of claim 8, wherein validating the threat hunting query further comprises at least one of:
comparing the threat hunting query against store grammar rules; or
comparing the threat hunting query against and endpoint of the database.

14. The system of claim 8, wherein validating the threat hunting query further comprises:
responsive to unsuccessful validation of the threat hunting query, regenerating the threat hunting query; and
responsive to a specified number of unsuccessful validations of the threat hunting query, rewriting the prompt again.

15. A computer program product for generating queries, the computer program product comprising:
a persistent storage medium having program instructions configured to cause one or more processors to:
receive input of a natural language prompt regarding computer system or network activity;
rewrite, by a large language model, the natural language prompt to produce a rewritten prompt, wherein the rewriting maps natural language descriptions of system behaviors to computer or network system actions and objects;
generate, by the large language model, a set of intermediate queries based on the rewritten prompt, wherein the intermediate query is in a language on which the large language model is trained;
translate the set of intermediate queries into a threat hunting query expressed in a threat hunting query language specific to a database that records the computer system or network activity;
validate the threat hunting query according to whether it is semantically valid and executable; and
responsive to a successful validation of the threat hunting query, execute the threat hunting query against the database.

16. The computer program product of claim 15, wherein rewriting the prompt further comprises knowledge infusion of expert knowledge from a number of data sources external to the large language model, wherein the rewritten prompt includes the expert knowledge.

17. The computer program product of claim 15, wherein rewriting the prompt further comprises query planning, wherein the prompt is organized into a number of sequential steps that define different query actions.

18. The computer program product of claim 15, wherein rewriting the prompt further comprises normalizing the prompt into a canonical representation that partitions the prompt into computer system categories of subjects, actions, and objects.

19. The computer program product of claim 15, wherein translating the set of intermediate queries into the threat hunting query further comprises:
performing schema refinement, wherein relevant parts are identified for a schema of the threat hunting query language specific to the database;
selecting a number of few-shot examples from a library of the threat hunting query language, wherein the few-shot examples are selected according to a specified threshold of a distance metric between the rewritten prompt and the examples in the library; and
generating the threat hunting query based on the schema refinement, few-shot examples, and rewritten prompt.

20. The computer program product of claim 15, wherein validating the threat hunting query further comprises:
responsive to unsuccessful validation of the threat hunting query, regenerating the threat hunting query; and
responsive to a specified number of unsuccessful validations of the threat hunting query, rewriting the prompt again.
